(19) United States
(12) Patent Application Publication
(10) Pub. No.: US 2023/0342586 A1
(43) Pub. Date: Oct. 26, 2023

(54) GRAPH SEARCH USING NEURAL NETWORK WITH SPIKING NEUROMORPHIC ARCHITECTURE

(71) Applicants: Ashish Rao Mangalore, Munich (DE); Philipp Stratmann, Bonn (DE); Gabriel Andres Fonseca Guerra, Munich (DE); Sumedh Risbud, Berkeley, CA (US); Garrick Michael Orchard, Santa Clara, CA (US); Andreas Wild, Portland, OR (US)

(72) Inventors: Ashish Rao Mangalore, Munich (DE); Philipp Stratmann, Bonn (DE); Gabriel Andres Fonseca Guerra, Munich (DE); Sumedh Risbud, Berkeley, CA (US); Garrick Michael Orchard, Santa Clara, CA (US); Andreas Wild, Portland, OR (US)

(21) Appl. No.: 18/346,966

(22) Filed: Jul. 5, 2023

(51) Int. Cl. G06N 3/04; G06N 3/084

(52) U.S. Cl. CPC G06N 3/04; G06N 3/084

(57) ABSTRACT

A graph includes nodes connected with one or more edges. Each node in the graph may be encoded in a neuron in a neural network. The neural network may include neurons arranged in a spiking neuromorphic architecture. To find the shortest path between a first node and a second node in the graph, a spike may propagate from a first neuron encoding the first node to a second neuron encoding the second node. Another spike may propagate from the second neuron to the first neuron. Each neuron spiking in a propagation may store a value that indicates the depth of the neuron in a propagation path. A spiking neuron may generate two values in the two propagations, respectively. A spiking neuron having two equal values may be identified. The shortest path includes one or more edges that connect the nodes encoded in the identified spiking neurons.

### TECHNICAL FIELD

This disclosure relates generally to graph search, and more specifically, graph search using neural networks with spiking neuromorphic architectures.

### BACKGROUND

A graph is a data structure comprising a collection of nodes (or vertices) and one or more edges. An edge is a connection of two nodes. Graphs are used in a wide variety of applications, including robotics, database queries, financial transactions, vehicle routing, logistics, social network analysis, and so on. A graph problem is the shortest path problem, which is the problem of finding a path between two nodes in a graph such that the number of edges (or the sum of the weights of the edges) between the two nodes is minimized.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a graph search system, in accordance with various embodiments.

FIG. 2 illustrates an example graph, in accordance with various embodiments.

FIGS. 3A and 3B illustrate a forward spike propagation in a neural network with a spiking neuromorphic architecture, in accordance with various embodiments.

FIGS. 4A-4F illustrate a backward spike propagation in the neural network in FIG. 3, in accordance with various embodiments.

FIG. 5 illustrates an example spiking neuromorphic unit, in accordance with various embodiments.

FIG. 6 illustrates an example process of planning motion of a robot using the graph search system in FIG. 1, in accordance with various embodiments.

FIG. 7 is a flowchart showing a method of graph search, in accordance with various embodiments.

FIG. 8 is a block diagram of an example computing device, in accordance with various embodiments.

### DETAILED DESCRIPTION

### Overview

Finding the shortest path in a graph problem usually involves application of shortest path algorithms (e.g., the Dijkstra's algorithm), the Bellman-ford algorithm, or heuristics-based search algorithms (e.g., A*search algorithm). In some applications (e.g., robotics, where the robot is often required to react in real-time), currently available computer architectures for solving graph problems (e.g., central processing unit (CPU), graph processing unit (GPU), etc.) can be prohibitively slow or require the use of very compute-heavy, energy-intensive computers, which limits (or even eliminates) their use in environments with limited computing resources, such as mobile robots, and so on.

For example, solving the shortest path problem on CPUs involves serially exploring possible paths in the graph, which can lead to slow performance. Also, parallel search strategies on graphics processing units (GPUs) are limited in exploiting the parallelism inherent to the graphs. Due to the small core count compared to graph size, GPUs need to perform the search in batches. However, because GPUs do not integrate compute and memory, batching results in costly data transfer. Application Specific Integrated Circuits (ASICs) are also used to solve the shortest path problem. However, the use of ASICs based solutions can restrict the application of the solution to a particular variant of the problem and do not offer generalizability. ASICs can consume orders of magnitude higher energy than CPUs or GPUs and therefore, limiting their application in problems with hundreds of millions of graph nodes.

Embodiments of the present disclosure may improve on at least some of the challenges and issues described above by using neural networks with spiking neuromorphic architectures to find the shortest path in a graph problem. A graph may be encoded in a neural network having a spiking neuromorphic architecture. The neural network can be executed using a spiking neuromorphic unit, which is a programmable processing unit that can support spiking neuromorphic architectures.

In various embodiments of the present disclosure, graph problems (e.g., finding the shortest path between two nodes in the graph) may be solved by using a graph search system that includes the spiking neuromorphic unit and a graph search module. The spiking neuromorphic unit may include a plurality of compute elements, each of which may be used as a neuron. The graph search module may be implemented or executed using a different processing unit (e.g., a CPU, etc.) from the spiking neuromorphic unit.

A graph may include nodes connected with one or more edges. The nodes in the graph may be mapped to neurons in the spiking neuromorphic unit. An individual neuron may encode a single node in the graph. An edge in the graph may be encoded by a communicative connection between the two corresponding neurons. The neurons and their connections constitute a neural network with a spiking neuromorphic architecture. To find the shortest path between a first node and a second node in the graph, a spike may propagate from a first neuron encoding the first node to a second neuron encoding the second node. The spike may pass one or more other neurons in the neural network in the propagation. Another spike may propagate in the opposite direction, i.e., from the second neuron to the first neuron. A neuron spiking in a propagation may store a value that indicates the depth of the neuron in the corresponding propagation path. A spiking neuron may generate two depth values in the two propagations, respectively. The spiking neuron determines whether the two depth values match, e.g., whether they are equal. After determining that the two depth values are equal, the spiking neuron may send its identifying information to a graph search module. A spiking neuron with two equal depth values encodes a node on the shortest path or one of the shortest paths. The graph search module can determine the shortest path by identifying the nodes encoded by the spiking neurons that send identifying information to the graph search module.

The spiking neuromorphic unit can support fine-grained parallelism that is adaptable to the parallelism of graph problems. This can enable the solution to a graph problem (e.g., the shortest path) to be found quickly. Also, the graph search module can ensure efficient readout of the sequence of nodes that constitute the solution. The complexity of the neuromorphic solution may scale with the actual length of the shortest path. A sequential algorithm on a separate processing unit (e.g., CPU) may scale with the number of edges. Also, the spiking neuromorphic unit can be aware of sparsity in data and operate or communicate on a need-to-use basis. For instance, the compute elements in spiking neuromorphic unit can operate or communicate asynchronously. Thus, the energy consumption for solving graph problems and for solution readout can be minimized.

The spiking neuromorphic unit can also scale well for graphs with a large number of nodes (e.g., up to millions, hundreds of millions, etc. nodes). The programmability of the spiking neuromorphic unit can allow it to be used for various types of graphs, including dynamically changing graphs, constrained graphs, graphs with constraints on the weights/nodes of the shortest path, and so on. Compared with the currently available techniques, the present disclosure provides a faster and more energy efficient approach to find shortest paths in graphs and to read out nodes that constitute shortest paths. The graph search system in the present disclosure can be used in mobile applications or applications that are limited by power or computation capacity.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phase “A or B” means (A), (B), or (A and B). For the purposes of the present disclosure, the phrase “A, B, and/or C” or the phase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example Graph Search System

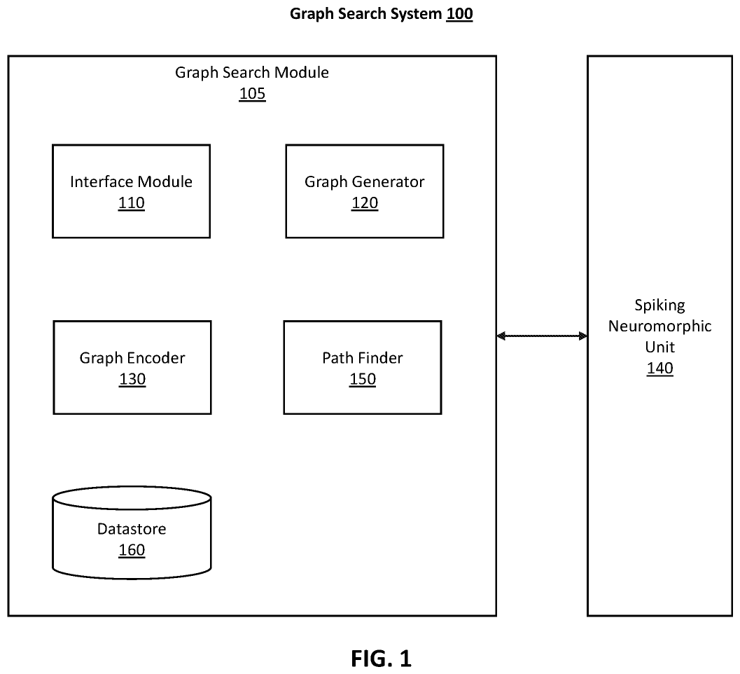

FIG. 1 is a block diagram of a graph search system 100, in accordance with various embodiments. The graph search system 100 includes a graph search module 105 and a spiking neuromorphic unit 140. The graph search module 105 includes an interface module 110, a graph generator 120, a graph encoder 130, a path finder 150, and a datastore 160. In other embodiments, alternative configurations, different or additional components may be included in the graph search system 100. Further, functionality attributed to a component of the graph search system 100 may be accomplished by a different component included in the graph search system 100 or by a different system.

The graph search system 100 may be implemented in software, hardware, firmware, or some combination thereof. In some embodiments, the spiking neuromorphic unit 140 may be a processing unit that can execute neural networks with spiking neuromorphic architectures. The graph search module 105 may be implemented or executed in a processing unit that is separate from the spiking neuromorphic unit 140. The two processing units may be arranged in the same chip or different chips.

In some embodiments, one or more components of the graph search system 100 may be on a separate processing unit from one or more other components of the graph search system 100. In an example, one or more of the interface module 110, graph generator 120, graph encoder 130, path finder 150, and datastore 160 may be facilitated by one or more CPUs. The spiking neuromorphic unit 140 may be facilitated by a different processing unit that has a spiking neuromorphic architecture.

The interface module 110 facilitates communications of the graph search system 100 with one or more other systems. For example, the interface module 110 may receive data from one or more systems or devices, the operation of which may produce data that can be used to solve graph problems. The data may be used by the graph generator 120 to define a graph problem, generate a graph, etc. As another example, the interface module 110 may transmit data computed by the graph search system 100 to one or more systems or devices that may operate based on solutions found by the graph search system 100. Examples of systems or devices that send data to or receive data from the interface module 110 may include robots, navigation systems, e-marketing systems, control systems, mapping systems, depth measurement systems, and so on.

The graph generator 120 generates graphs. The graphs can be used for various applications, such as robotics, database queries, financial transactions, vehicle routing, logistics, social network analysis, and so on. A graph may be a data structure that includes nodes and edges. A node is an entity in the graph. A node may represent an object (person, animal, building, tree, vehicle, etc.), measurement (e.g., dimension, weight, pressure, volume, etc.), signal (e.g., text, image, video, audio, etc.), location, user account, and so on. An edge is a connection of two nodes. An edge may represent a relationship between the two nodes, such as affinity, connection, proximity, and so on. A node may be connected to multiple other nodes through multiple edges. A graph may be associated with one or more embeddings. For instance, the graph may have a graph embedding that encodes one or more characteristics of the graph, a node in the graph may have a node embedding that encodes one or more characteristics of the node, or an edge in the graph may have an edge embedding that encodes one or more characteristics of the edge. An embedding may be a vector, which is also referred to as embedding vector.

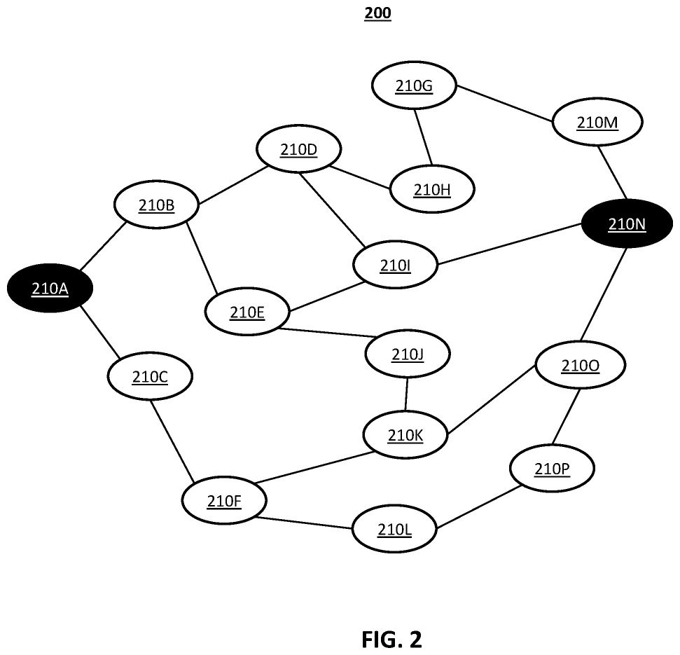

In some embodiments, the graph generator 120 may generate graphs based on data from a system or device associated with the graph search system 100. For example, the graph generator 120 may receive a request from a control system of a robot to plan a motion of the robot. The graph generator 120 may also receive information about the environment where the robot moves. The information about the environment may include sensor data captured by the robot. The graph generator 120 may generate a graph based on the request and the information of the environment. In other examples, the graph generator 120 may generate graphs to be used for other purposes. Certain aspects of graphs generated by the graph generator 120 are provided below in conjunction with FIG. 2.

The graph encoder 130 encodes graphs to neural networks with spiking neuromorphic architectures. The graph encoder 130 may receive a graph from the graph generator 120. The graph encoder 130 may encode the graph to a neural network comprising a plurality of neurons that are in communication. In some embodiments, the graph encoder 130 may encode a node in the graph to a neuron in the neural network. Different nodes may be encoded to different neurons. The graph encoder 130 may encode the edges in the graph to the communicative connection between the corresponding neurons. In some embodiments (e.g., embodiments where an edge has weights), the graph encoder 139 may introduce a delay proportional to the weight to the communicative connection between the corresponding neurons, which may delay the communication (e.g., transmission of spiking message) between the neurons.

The neural network may have a spiking neuromorphic architecture. A spike of information may propagate through the neurons in the neural network through the communitive communications. The information in the spike may include a variable defining a state of the spiking neuron, which may indicate an attribute of the node encoded by the neuron. In some embodiments, the variable may be a depth value that indicates the depth of the node on a path in the graph. The path may be between two nodes of the graph, e.g., a path from a start node to a target node. The graph may have multiple paths between the start node and the target node. The depth of the node may indicate the distance of the node from the start node on one of the paths. The variable defining the state of a neuron may be stored in a memory associated with the neuron as a memory flag. The graph encoder 130 may also determine one or more criteria for the neurons to spike. A neuron may spike after it meets a criterion. An example criterion may be setting a memory flag, e.g., by storing a depth value in a memory associated with the neuron.

The spiking neuron can transmit the spike of information to one or more other neurons that are in communitive connection with the spiking neuron. The spike may carry the memory flag of the spiking neuron. The graph encoder 130 may also instruct a neuron, which has received the spike, to compute a new value based on the value in the spike. In an example, the graph encoder 130 may instruct the neuron to increase the value in the spike by one. In another example, the graph encoder 130 may instruct the neuron to subtract one from the value in the spike.

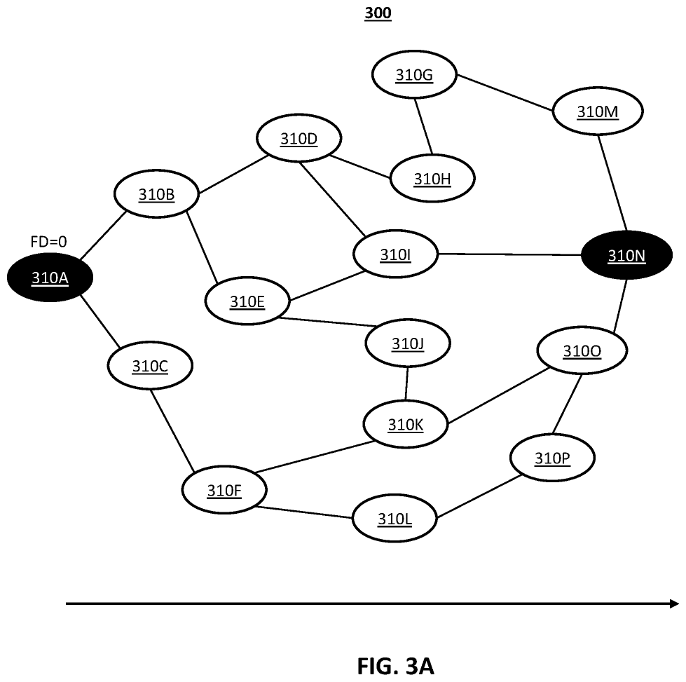

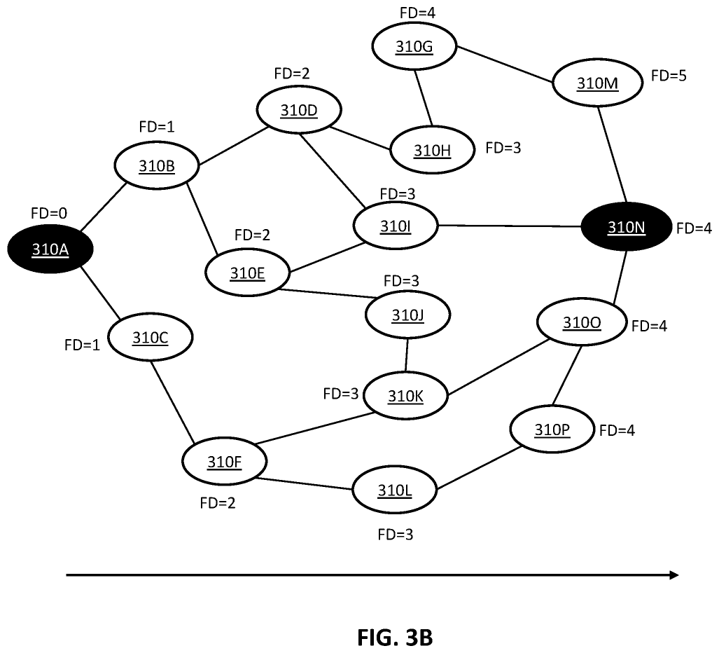

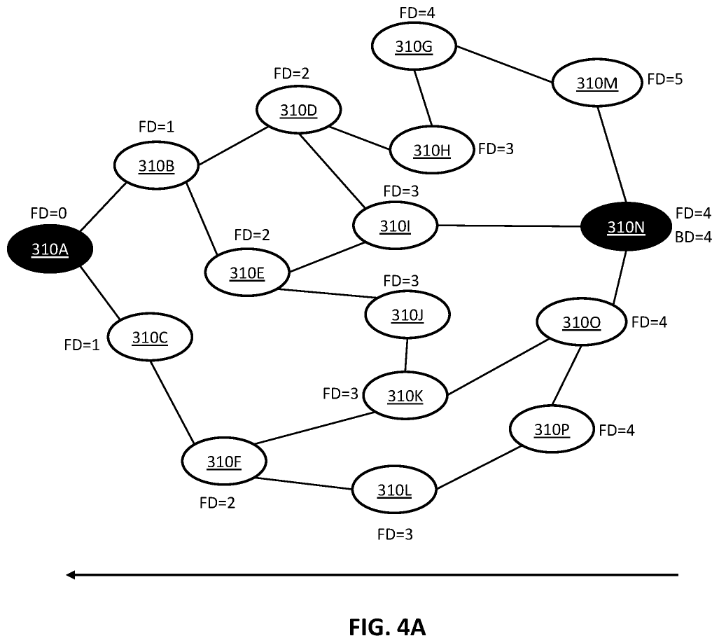

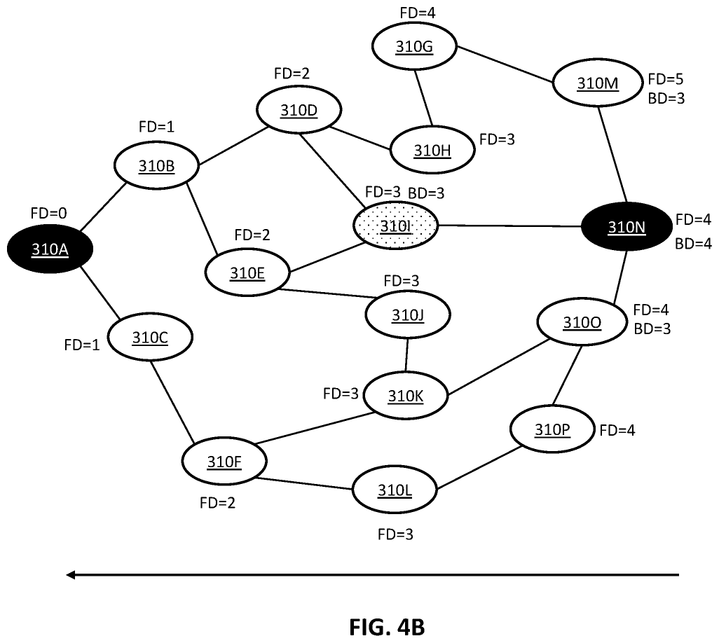

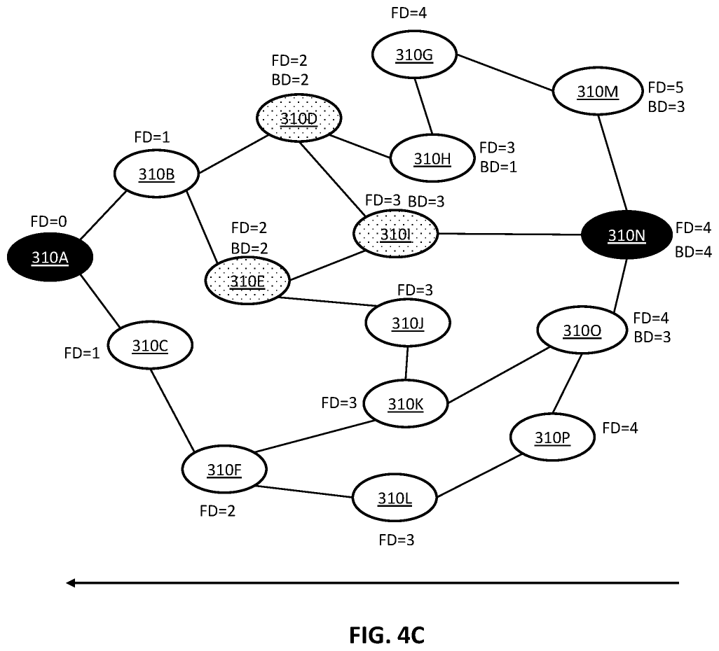

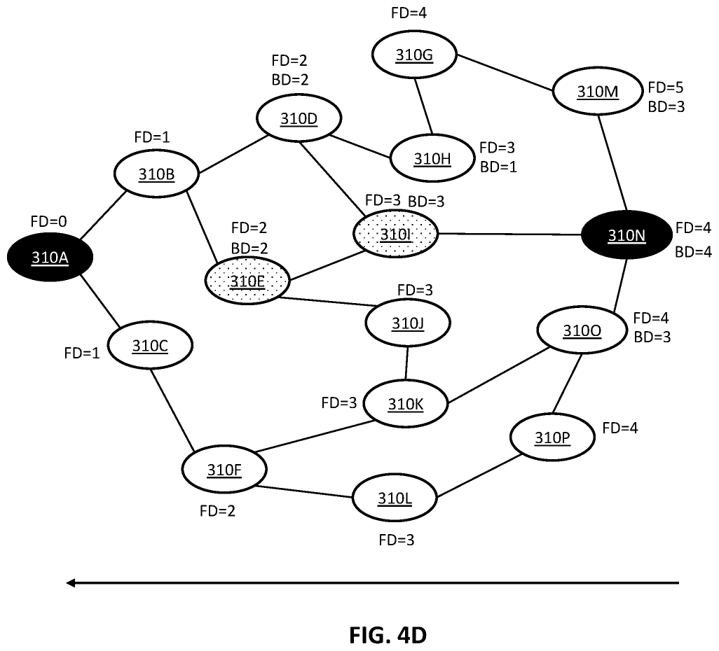

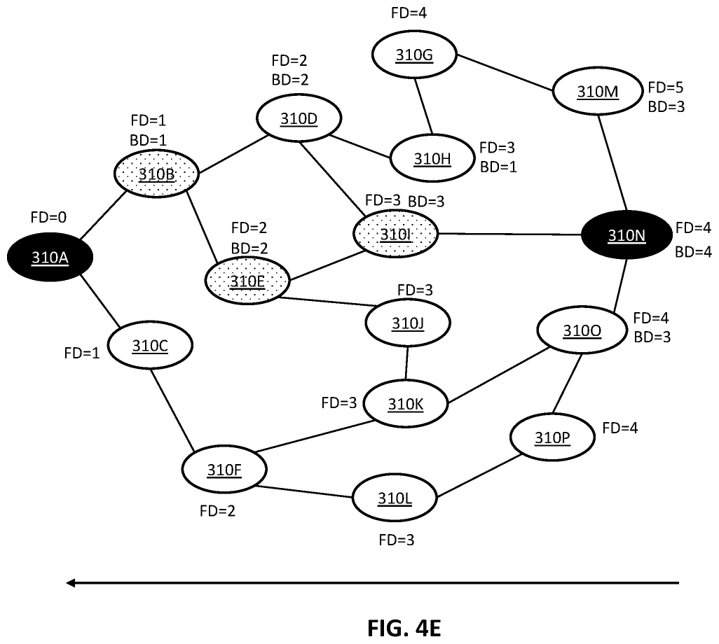

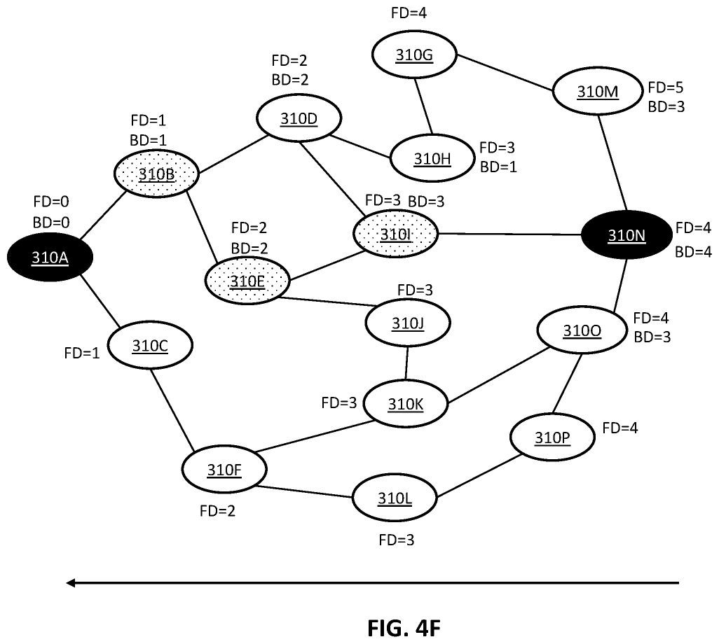

The graph encoder 130 may manage spike propagations in the neural network. For instance, the graph encoder 130 may select a neuron where a spike propagation starts. The neuron may be the start neuron of the spike propagation. The start neuron may encode a start node of a path in the graph, e.g., in embodiments where the spike propagation is a forward spike propagation, or a target node of a path in the graph, e.g., in embodiments where the spike propagation is a backward spike propagation. Additionally or alternatively, the graph encoder 130 may select a neuron where the spike propagation ends. The neuron may be the target neuron of the spike propagation. The target neuron may encode a target node of a path in the graph, e.g., in embodiments where the spike propagation is a forward spike propagation, or a start node of a path in the graph, e.g., in embodiments where the spike propagation is a backward spike propagation. In an embodiment, the graph encoder 130 may set the state of the start neuron or target neuron. For instance, the graph encoder 130 may set the depth value of the neuron encoding a start node to 0. Certain aspects of spike propagations are described below in conjunction with FIGS. 3A and 3B as well as FIGS. 4A-4F.

In some embodiments, the graph encoder 130 may obtain identifying information of the neurons encoding in the neural network. The identifying information of a neuron may include a serial number, ID number, location information, or other information that can identify the neuron in the neural network. Additionally or alternatively, the identifying information of a neuron may include information indicating which node in the graph is encoded by the neuron. For instance, the identifying information may include a serial number, ID number, position in the graph, information about connection with other neurons, or other information that can identify the node. The graph encoder 130 may provide the identifying information of the neurons to the path finder 150 for finding the shortest path in the graph.

The graph encoder 130 may also instruct neurons to provide their identifying information to the path finder 150 after one or more criteria is met. An example criterion may be the depth value of the neuron for a spike probation from a first neuron to a second neuron being equal to the depth value of the neuron for a spike probation from the second neuron to the first neuron.

The spiking neuromorphic unit 140 executes neural networks with spiking neuromorphic architectures, such as neural networks that encode graphs. The spiking neuromorphic unit 140 may include one or more compute blocks. Each compute block may include a plurality of compute element. A processing element can perform computations, such as accumulation, subtraction, multiplication, division, other types of computations, or some combination thereof. In some embodiments, a processing element may be a neuron. In other embodiments, multiple compute element may constitute a neuron. A compute element may be communicatively connected to one or more other compute element, which may be in the same compute block as the processing element or in a different compute block. In some embodiments, the communicative connection between two compute element may be facilitated by an in-memory compute elements (“synapses”). The compute element in communicative connection may send data to each other, e.g., when the compute element spike. The communication between two processing element may be bidirectional so that they can pass spikes to each other in both forward spike propagation and backward spike propagation.

In some embodiments, the spiking neuromorphic unit 140 may include one or more memories, which may be implemented on the same chip as the compute element. In an example, a compute block may have its own memory that is shared by the compute element in the compute block. The memory may store data computed by the compute element. In some embodiments, operations of the spiking neuromorphic unit 140 may be managed by the graph encoder 130.

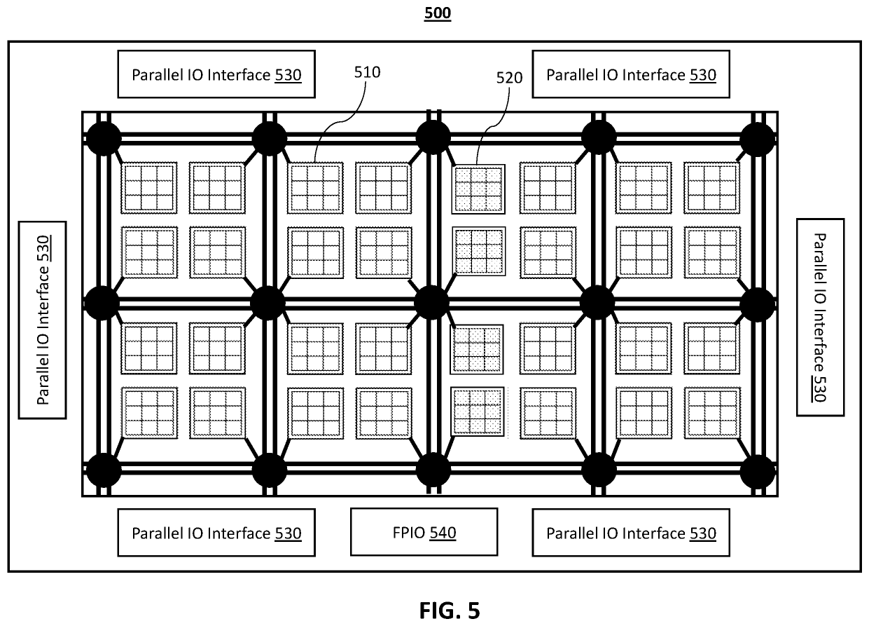

The spiking neuromorphic unit 140 may be programable, which can allow the usage of different types of update equations in a neuron in the neural network, thereby enabling the graph search system 100 to solve various graph search problems. In some embodiments, auxiliary operations can be integrated with graph search problem or performed along with graph search. The compute-memory architecture of the spiking neuromorphic unit 140 can reduce or minimize data transfer between compute and memory elements across compute cycles. Certain aspects of the spiking neuromorphic unit 140 are described below in conjunction with FIG. 5.

The path finder 150 finds the shortest paths in graphs. The path finder 150 may receive information about a graph from the graph generator 120, such as the nodes in the graph, edges in the graph, and so on. In some embodiments, the path finder 150 may also receive, e.g., from the graph generator 120, information indicating a start node and a target node, between which the shortest path needs to be found. The path finder 150 may also receive information about the neural network that encodes the graph from the graph encoder 130, such as identifying information of the neurons in the neural network, communitive connections between the neurons, and so on. The path finder 150 may receive identifying information of neurons (e.g., a subset of the neurons in the neural network) from the spiking neuromorphic unit 140 executing the neural network.

The path finder 150 may identify one or more nodes in the graph based on information received from the graph generator 120, the graph encoder 130, the spiking neuromorphic unit 140, or some combination thereof. The path finder 150 may determine the shortest path from the start node to the target node based on the identified nodes. The shortest path may include the start node, the identified node(s), the target node, and the edges between these nodes. The shortest path may be a solution to a graph problem based on which the graph generator 120 generates the graph. In some embodiments, the path finder 150 may provide the shortest path to a system or device associated with the graph search system, where the shortest path may be used for various applications.

The datastore 160 stores data received, generated, used, or otherwise associated with the graph search system 100. For example, the datastore 160 stores graphs generated by the graph generator 120, data used by the graph generator 120 to generate graphs, data provided to or generated by the spiking neuromorphic unit 140, information of paths found by the path finder 150, and so on. In the embodiment of FIG. 1, the datastore 160 is a component of the graph search system 100. In other embodiments, the datastore 160 may be external to the graph search system 100 and communicate with the graph search system 100 through a network. In some embodiments, part of the datastore 160 may be implemented in the spiking neuromorphic unit 140. For instance, the spiking neuromorphic unit 140 may include one or more memories that store data provided to or generated by the compute element in the spiking neuromorphic unit 140.

### Example Process of Graph Search

FIG. 2 illustrates an example graph 200, in accordance with various embodiments. The graph 200 is a data structure including a collection of nodes 210A-210P (collectively referred to as “nodes 210” or “node 210”). The lines linking the nodes 210 indicate connections between the nodes 210. A connection in the graph 200 is referred to as an edge. The nodes 210 and edges in FIG. 2 are shown for the purpose of illustration. In other embodiments, the graph 200 may include a different number of nodes or different edges.

The graph 200 may be used to represent various types of data, such as text, image, data about a social network, and so on. In an example where the graph 200 represents an image, a node 210 may represent a feature in the image. The edges may indicate relationships between the features in the image. A node 210 may be associated with an embedding that encodes information about the feature, such as color, shape, size, classification, and so on. In another example, the graph 200 may represent an area, e.g., an area surrounding a robot. A node 210 may represent a spot or object in the area. An edge may indicate a traveling path in the area. In another example, the graph 200 may represent a social network. A node 210 may represent a person using the social network. The edges may indicate affinity among the people in the social network. In other examples, the graph 200 may represent other data.

The graph may be used to solve a problem using machine learning techniques. The problem may include finding the shortest path between two nodes 210 in the graph 200. In an example, the two nodes 210 may be the node 210A and the node 210N. In some embodiments, the shortest path may be unidirectional. For example, the node 210A may be the start node, the node 210N may be the end node or target node, and shortest path may be from the node 210A to the node 210N. As another example, the node 210N may be the start node, the node 210A may be the end node or target node, and shortest path may be from the node 210N to the node 210A. In other embodiments, the shortest path may be bidirectional.

FIGS. 3A and 3B illustrate a forward spike propagation in a neural network with a spiking neuromorphic architecture, in accordance with various embodiments. The neural network encodes a graph, an example of which is the graph 200 in FIG. 2. The neural network includes neurons 310A-310P (collectively referred to as “neurons 310” or “neuron 310”). The lines linking the neurons 310 indicate communicative connections between the neurons 310. The neurons 310 may communicate with each other asynchronously using spikes that can be graded (have a range of values) or binary. For the purpose of illustration, FIGS. 3A and 3B show 16 neurons. In other embodiments, the neural network may include a different number of neurons or connections between neurons.

Each neuron 310 may be a processing element that can perform computations, such as subtraction, accumulation, multiplication, and so on. The connections between the neurons 310 may mirror the edges in the graph encoded by the neural network. A neuron 310 may send data to one or more other neurons 310 that the neuron 310 is communicatively connected with. In some embodiments, a neuron 310 may receive data from another neuron 310 and compute new data based on the received data. A neuron 310 may send out data, such as data computed by the neuron 310, when it spikes. A neuron 310 may store data that is received or generated by the neuron 310 in a memory associated with the neuron 310. In some embodiments, a group of neurons 310 may share a single memory. The memory (or memories) and the neurons 310 may be implemented on the same chip.

Spikes may propagate through various paths in the neural network. In some embodiments, a spike of information may propagate through multiple paths in the neural network. The multiple paths may have different lengths. A spike propagation may be initiated at a start neuron 310, proceeds to the neurons 310 directly connected to the start neuron 310, and further proceeds to other neurons 310 directly connected to those neurons 310. The spike propagation may stop when the last neuron 310 in the path (or all paths) of the propagation is reached. The information in the spike may include a value that can be changed by the neurons 310 that receive the spike during the propagation.

In the embodiments of FIGS. 3A and 3B, the forward spike propagation is from the neuron 310A to the neuron 310N. FIG. 3A shows the initiation of the forward spike propagation. The forward spike propagation is initiated at the neuron 310A. The neuron 310A may set a memory flag. For instance, the neuron 310A may store a forward depth value (represented by “FD” in FIGS. 3A and 3B) in a memory. The forward depth value may indicate the depth of the neuron 310A in one or more paths of the forward spike propagation. In the embodiments of FIG. 3A, the forward depth value of the neuron 310A is 0, indicating that the neuron 310A is the first neuron for the forward spike propagation. In some embodiments, the forward depth value of the neuron 310A may be provided by a graph encoder, such as the graph encoder 130 in FIG. 1.

In FIG. 3B, the neuron 310A passes the spike to downstream neurons 310, i.e., neurons 310 that are connected to the neuron 310A. For instance, the neuron 310A sends its forward depth value to each of the neurons 310B and 310C. The neuron 310B receives the forward depth value of the neuron 310A and determines a new forward depth value by increasing the forward depth value of the neuron 310A by 1. The neuron 310B sets a memory flat with the new forward depth value and passes a spike with the new forward depth value to the neurons 310D and 310E. Similarly, the neuron 310C also computes and stores a new forward depth value of 1. The neuron 310C passes a spike with the new forward depth value to the neuron 310F.

The neurons 310D and 310E each increase the forward depth value of the neuron 310B by 1 and compute a new forward depth value of 2, which can be stored in the memory associated with the neurons 310D and 310E. The neurons 310D and 310E spike with the new forward depth value and sends the new forward depth value to the neurons 310H, 310I, and 310J. Similarly, the neuron 310F also computes and stores a new forward depth value of 2 and sends the new forward depth value to the neurons 310K and 310L.

As the forward spike propagation proceeds, the neurons 310H, 310I, 310J, 310K, and 310L each compute a forward depth value of 3 and spikes to send the forward depth value to the neuron 310G connected to the neuron 310H, 310N connected to the neuron 310I, 310K connected to the neuron 310J, and the neuron 310L connected to the neuron 310F. The neurons 310G, 310N, and 310L each compute and store a new forward depth value of 4.

The neuron 310K already has a forward depth value of 3, which was computed based on the spike from the neuron 310F. The neuron 310K may keep the forward depth value of 3 as its memory flag. In some embodiments, a neuron 310 may get multiple different forward depth values in the same spike propagation. The neuron 310K is an example. It receives spikes from the neuron 310F and the neuron 310J, and the two spikes have different values. In some embodiments, the neuron 310K may select the smallest forward depth value. For instance, the neuron 310K may compute a new forward depth value of 4 based on the spike from the neuron 310J and compare the new forward depth value with the previously stored forward depth value. After determining that the new forward depth value is larger, the neuron 310K may make no change to its memory flag. After determining that the new forward depth value is smaller, the neuron 310K may reset its memory flag to the new forward depth value. The new forward depth value may replace the previously stored forward depth value in the memory.

In other embodiments, the neuron 310K may select the forward depth value that is received the earliest. For instance, the neuron 310K may store the first forward depth value it computes as its memory flag. After that, even though the neuron 310K receives another spike and optionally computes another forward depth value, it does not change the memory flag.

The neuron 310K may spike with the selected forward depth value and transmit the selected forward depth value to the neurons 310J and 310O. The neuron 310J also receives two spikes, one from the neuron 310E and one from the neuron 310K. The neuron 310J may compute two forward depth values and select one of the forward depth values, e.g., using one of the approaches described above. In the embodiments of FIG. 3B, the neuron 310J stores the forward depth value of 3.

The neurons 310G, 310N, 310O, and 310P each compute and store a forward depth value of 4 based on spikes from the neurons 310H, 310I, 310K, and 310L, respectively. The neuron 310O may also compute a forward depth value of 5 based on a spike of the neuron 310P but determine to use the forward depth value of 4 as its memory flag. The neuron 310M computes and stores a forward depth value of 5 based on the spike from the neuron 310G. The neuron 310M may spike and send the forward depth value of 5 to the neuron 310N. The neuron 310N may compute a forward depth value of 6 based on the spike from the neuron 310M but determine to use the forward depth value of 4 as its memory flag.

In some of the embodiments described above, the forward depth value of a neuron 310 is determined based on the forward depth value of another neuron 310 that transmits a spike to the neuron 310. In other embodiments, the forward depth value of a neuron 310 may be determined based on the time (e.g., based on the clock cycle) when the neuron 310 receives the spike. For instance, the neuron 310A may send out a spike in cycle 0 (or time step 0), the neurons 310B and 310C may receive the spike in cycle 1 (or time step 1), and the neurons 310D, 310E, and 310F may receive the spike in cycle 2 (or time step 2). Also, the neurons 310H, 310I, 310J, 310K, and 310L may receive the spike in cycle 3 (or time step 3). Further, the neurons 310G, 310O, and 310P may receive the spike in cycle 4 (or time step 4). The forward depth values of these neurons 310 may be determined based on which cycles (or time step) these neurons 310 receive the spike. The cycle (or time step) in which a neuron 310 receives the spike may indicate the depth of the neuron 310 on the spike propagation path, as the deeper the neuron 310 is located, the longer it takes for the spike to reach the neuron 310.

The spike propagation in FIGS. 3A and 3B is a forward spike propagation as the neuron 310A encodes a start node and the neuron 310N encodes a target node. In other embodiments (e.g., embodiments where the neuron 310A encodes a target node and the neuron 310N encodes a start node), the spike propagation in FIGS. 3A and 3B may be a backward spike propagation.

As shown in FIGS. 3A and 3B, there are a plurality of paths to propagate a spike from the neuron 310A to 310N. The lengths of the paths are different. In some embodiments, the length of a path may be the number of connections on the path, each connection is between two neighboring neurons 310. Even though all the neurons 310 spike and set memory flags in FIG. 3B, one or more neurons 310 may not spike or set memory flags during the forward spike propagation in other embodiments. For instance, the arrival of the spike reaching the neuron 310N encoding the target node may trigger termination of the forward spike propagation. The spike would not be send to the neuron 310M, and the neuron 310M would not compute any front depth value. The arrival of the spike reaching the neuron 310N may also trigger the start of a backward spike propagation, where a spike starts from the neuron 310M and proceeds towards the neuron 310A.

FIGS. 4A-4F illustrate a backward spike propagation in the neural network in FIG. 3, in accordance with various embodiments. The backward spike propagation may start after the forward spike propagation in FIGS. 3A and 3B is completed. The backward spike propagation is in the opposite direction from the forward spike propagation. The backward spike propagation starts at the neuron 310N and ends at the neuron 310A through various paths between these two neurons 310.

FIG. 4A shows the initiation of the backward spike propagation. The backward spike propagation is initiated at the neuron 310N. The neuron 310N may set a memory flag. For instance, the neuron 310N may store a backward depth value (represented by “BD” in FIGS. 4A-4F) in the memory. The backward depth value may indicate the depth of the neuron 310N in one or more paths of the forward spike propagation. In the embodiments of FIG. 4A, the backward depth value of the neuron 310N is 4, which is equal to the forward depth value of the neuron 310N that is generated during the forward spike propagation.

In FIG. 4B, the neuron 310N spikes and sends its backward depth value to the neurons 320M, 310I, and 310O. Each of these three neurons 310 generates a new backward depth value by subtracting one from the backward depth value form the neuron 310N, resulting in a backward depth value of 3. Each of these three neurons 310 may store the backward depth value in a memory. Also, each of these three neurons 310 compares its backward depth value with its forward depth value generated during the forward spike propagation. Each of the neurons 320M and 310O may determine that its backward depth value is not equal to its forward depth value. Based on such a determination, the neurons 320M and 310O may select not to spike and not to send their backward depth values to other neurons.

The neuron 310I may determine that its backward depth value is equal to its forward depth value. Based on such a determination, the neuron 310I may transmit its identifying information to a module (e.g., the path finder 150) for finding the shortest path in the graph. The neuron 310I is considered as a neuron on the shortest path. Also, the neuron 310I may spike and send its backward depth value to the neurons 310D and 310E.

In FIG. 4C, the neurons 310D and 310E receive the backward depth value of the neuron 310I and subtract one from the backward depth value of the neuron 310I, resulting in a new backward depth value of 2. The neurons 310D and 310E may store the backward depth value. Each of the neurons 310D and 310E compare its backward depth value with its forward depth value and determine that the two values match. In some embodiments, both of the neurons 310D and 310E send their identifying information to the path finder 150. In other embodiments, one of the neurons 310D and 310E sends out its identifying information but the other one does not. For instance, the neuron 310D or 310E, which computes or stores the backward depth value first, sends out its identifying information.

In FIG. 4D, the neuron 310E is selected over the neuron 310D. The neuron 310E sends out its identifying information and spikes to send the backward depth value to the neuron 310B.

In FIG. 4E, the neuron 310B generates a new backward depth value by subtracting one from the backward depth value form the neuron 310E, resulting in a backward depth value of 1. The neuron 310B may store the backward depth value in a memory. The neuron 310B determines that its backward depth value matches its forward depth value and sends its identifying information to the path finder 150. The neuron 310B also spikes and sends its backward depth value to the neuron 310A.

In FIG. 4F, the neuron 310A generates a new backward depth value by subtracting one from the backward depth value form the neuron 310B, resulting in a backward depth value of 0. The backward depth value of 0 indicates that the backward spike propagation ends as the start neuron has been reached. In some embodiments, the neuron 310A may send its identifying information, its backward depth value, or other information to the path finder 150 to inform the path finder 150 that the start neuron was reached.

In some of the embodiments described above, the backward depth value of a neuron 310 is determined based on the backward depth value of another neuron 310 that transmits a spike to the neuron 310. In other embodiments, the backward depth value of a neuron 310 may be determined based on the time (e.g., based on the clock cycle) when the neuron 310 receives the spike. For instance, the neuron 310N may send out a spike in cycle 0 (or time step 0), and the neurons 310M, 310I, and 310O may receive the spike in cycle 1 (or time step 1). The neurons 310D and 310E may receive the spike in cycle 2 (or time step 2). The neuron 310B may receive the spike in cycle 3 (or time step 3). The neuron 310A may receive the spike in cycle 4 (or time step 4). The forward depth values of these neurons 310 may be determined based on which cycles (or time step) these neurons 310 receive the spike. The cycle (or time step) in which a neuron 310 receives the spike may indicate the depth of the neuron 310 on the spike propagation path, as the deeper the neuron 310 is located, the closer it is to the neuron 310N, and the sooner it takes for the spike to reach the neuron 310.

Based on the forward spike propagation and the backward spike propagation, the shortest path between the neuron 310A and the neuron 310N is found. The shortest path includes the neurons 310A, 310B, 310E, 310I, and 310N as well as the connections between these five neurons 310. The identifying information of these neurons 310 can be used by the path finder 150 to identify the corresponding nodes (and optionally edges) in the graph and therefore, find the shortest path in the graph.

In embodiments where the neuron 310A encodes the start node and the neuron 310N encodes the target node, the order of the path finder 150 receiving identifying information of neurons 310 may be opposite to the order of the nodes in the shortest path. In other embodiments, the graph encoder 130 may reverse the neurons 310 encoding the start node and target node. For instance, the neuron 310A may encode the target node, and the neuron 310N may encode the start node. This way, the path finder 150 may receive identifying information of neurons on the shortest path in an order that matches the order of the nodes on the shortest path.

As shown in FIGS. 3B and 4F, more neurons 310 spike in the forward spike propagation than the backward spike propagation. This is because any neuron 310 whose backward depth value does not match its forward depth value would not spike in the backward spike propagation. This can make the backward spike propagation more efficient and consume less time and computing resources.

### Example Spiking Neuromorphic Unit

FIG. 5 illustrates an example spiking neuromorphic unit 500, in accordance with various embodiments. The spiking neuromorphic unit 500 may be an embodiment of the spiking neuromorphic unit 140 in FIG. 1. The spiking neuromorphic unit 500 includes compute units 510 (individually referred to as “compute unit 510”), compute units 520 (individually referred to as “compute unit 520”), parallel input/output (10) interfaces 530 (individually referred to as “parallel 10 interface 530”), and a tour pin input/output (FPIO) interface 540. In other embodiments, alternative configurations, different or additional components may be included in the spiking neuromorphic unit 500. For example, the spiking neuromorphic unit 500 may include a different number of compute unit, parallel 10 interface, or FPIO interface. As another example, the layout of the compute units 510 and 520 may be different. Further, functionality attributed to a component of the spiking neuromorphic unit 500 may be accomplished by a different component included in the spiking neuromorphic unit 500 or by a compute block.

The compute units 510 can train or deploy spiking neural networks, such as a neural network encoding a graph. A compute unit 510 may be referred to as a neural core. A neural core may include a plurality of neurons that may be integrated together. A neuron may be a compute element that can perform computations. For the purpose of illustration, a compute unit 510 includes nine neurons in FIG. 5. In other embodiments, a compute unit 510 may include a different number of neurons. For instance, the number of neurons in a compute unit 510 may be in a range from 100 to 1000. A compute unit 510 may be associated with a limited internal memory that can be accessed by the neurons during execution.

The neurons can communicate with each other asynchronously using binary (single-bit) or graded (multiple-bit) spikes or messages. In some embodiments, some or all the compute units 510 may be devoid of a clock. The notion of a time-step may be maintained by a synchronization process that is a handshaking mechanism between the compute units 510 that is run when the spikes generated for each compute unit 510 are sent out. This can flush out all the remaining spiking activity and prepares the compute units 510 for the next algorithmic time-step. Message passing can be done by using physical interconnects between the compute unit 510 or between neurons. The physical interconnects are represented by the dark lines and black circles in FIG. 5.

A compute unit 520 may be a CPU or part of a CPU (e.g., compact Von Neumann CPUs). The compute units 520 may execute special functions not tenable on the computing units 510, e.g., some or all functions of the graph search module 105. In some embodiments, the compute units 520 are implemented on the same chip(s) as the compute units 510. In other embodiments, the compute units 520 are implemented on separate chips from the compute units 510.

The chip(s) can be scaled to increase the number of compute units 510 or 520, e.g., to accommodate large graphs. The chip-to-chip communication may be facilitated using the parallel 10 interfaces 530 or the FPIO interface 540. The parallel 10 interfaces 530 or the FPIO interface 540 can also offer support for Ethernet-based communication or other types of communications, such as slow serial communication.

### Example Motion Planning Process

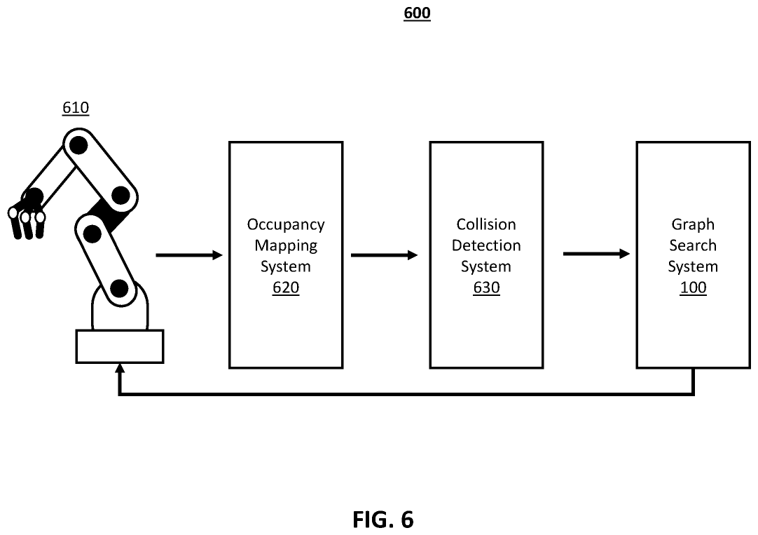

FIG. 6 illustrates an example process 600 of planning motion of a robot 601 using the graph search system 100 in FIG. 1, in accordance with various embodiments. For the purpose of illustration, the robot 601 has a movable arm. In other embodiments, the robot 601 may be different. For instance, the robot 601 may be an autonomous vehicle, a robot with different movable components, and so on.

The robot 610 may send a request to an occupancy mapping system 620 for mapping the occupancy of an environment where the robot 601 operates. In some embodiments, the robot 610 may provide sensor data captured by one or more sensors of the robot 610 to the occupancy mapping system 620. The sensor data may include images, point cloud, and so on.

The occupancy mapping system 620 may generate an occupancy model, such as an occupancy grid, etc. The occupancy model may include information indicating presence of one or more objects in the environment that may be obstacles of the robot 610 moving in the environment. In an embodiment, the occupancy mapping system 620 may generate an occupancy model including occupancy representations. An occupancy representation may be a representation of an object or one or more portions of an object or a representation of the space occupied by an object or one or more portions of an object. The occupancy mapping system 620 may generate occupancy representations by using geometric algorithms. The occupancy mapping system 620 may send the occupancy model to a collision detection system 630.

The collision detection system 630 may detect potential collisions of the robot 610 in the environment. For instance, the collision detection system 630 may detect obstacles in the environment for the robot 610 based on the occupancy model from the occupancy mapping system 620. For instance, the collision detection system 630 may determine whether an object is, could be, or will be an obstacle of the robot 610 based on the occupancy representation of the object. In some embodiments, the object is an obstacle of the robot 610 in scenarios where the object has collided, is colliding, or will collide with the robot 610 or the object can interfere with a movement of the robot 610, for instance, the object blocks a route along which the robot 610 travels. The collision detection system 630 may send information of the detected obstacles to the graph search system 100. The information may include locations of the detected obstacles, sizes of the detected obstacles, shapes of the detected obstacles, and so on.

The graph search system 100 may define a graph problem based on the information of the detected obstacles from the collision detection system 630. For instance, the graph search system 100 may generate a graph that represents at least part of the environment. A node in the graph may be a location in the environment. The location may be a destination of the robot 610, e.g., a location where the robot 610 is required to visit for completing a task. An edge between two nodes may represent a traveling path in the environment that has no detected obstacles.

The graph search system 100 may define a start node representing a location where the movement of the robot 610 starts and a target node representing a destination where the movement of the robot 610 ends.

The graph search system 100 may use a neural network with a spike neuromorphic architecture to find the shortest path between the start location to the destination. In some embodiments, the graph search system 100 encodes the graph into a neural network including a plurality of neurons, each of which may encode a respective node in the graph. The neurons may be communicatively connected, and the communicative connection may represent the edges between the nodes encoded by the neurons.

The graph search system 100 can cause a forward spike propagation (an example of which is the forward spike propagation in FIGS. 3A and 3B) and a backward spike propagation (an example of which is the backward spike propagation in FIGS. 4A-4F) in the neural network. Based on the two spike propagations, the graph search system 100 may identify neurons that encode the nodes on the shortest path. Further, the graph search system 100 can identify the nodes and determine the shortest path based on the identified nodes. The shortest path includes the start node, target node, identified node, and the edges between these nodes. The graph search system 100 may send the shortest path to the robot 610. The robot 610 may plan its motion based on the shortest path so that the robot 610 may reach the destination form the start location by taking the shortest path.

Even though FIG. 6 describes motion planning for the robot 610, the graph search system 100 may be used in other applications. For instance, the graph search system 100 may be used for e-marketing applications, such as routing and scheduling problems, arbitrage problems, and so on. The shortest path problem can be the backbone of routing and scheduling applications, such as routing in networks to minimize the number of hops between routers from source to destination, scheduling trains or flights, and so on.

Arbitrage is the act of buying or selling things across different markets, or in different forms, to profit from differences in prices. Arbitrage may involve making trade at very high speeds to exploit windows of opportunity. The arbitrage problem can be represented as graphs and decision to be taken as the nodes constituting the shortest path. Records of financial transactions may be stored as graphs. Implementation of shortest path search algorithms can be used to recognize and flag fraudulent transactions when used in conjunction with other machine-learning based classifiers. In an ecosystem of buyers and sellers interacting with one another, the trust between different members can be modelled as a function of the depth of the graph (e.g., value of the shortest path) of transactions connecting the different members.

### Example Method of Graph Search

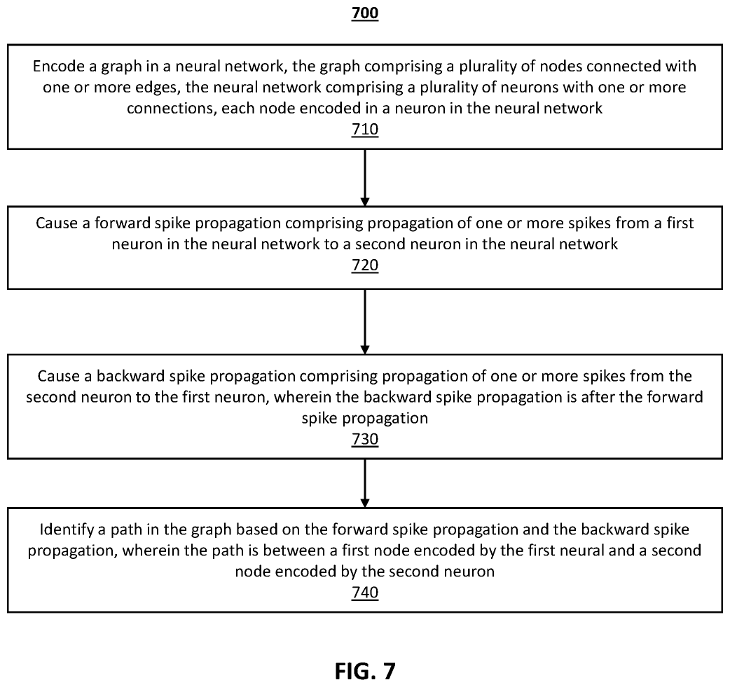

FIG. 7 is a flowchart showing a method 700 of graph search, in accordance with various embodiments. The method 700 may be performed by the graph search system 100 in FIG. 1. Although the method 700 is described with reference to the flowchart illustrated in FIG. 7, many other methods for graph search may alternatively be used. For example, the order of execution of the steps in FIG. 7 may be changed. As another example, some of the steps may be changed, eliminated, or combined.

The graph search system 100 encodes 710 a graph in a neural network. The graph comprises a plurality of nodes connected with one or more edges. The neural network comprising a plurality of neurons with one or more connections. Each node is encoded in a neuron in the neural network.

The graph search system 100 causes 720 a forward spike propagation comprising propagation of one or more spikes from a first neuron in the neural network to a second neuron in the neural network. In some embodiments, the forward spike propagation has a plurality of spiking neurons that comprises the first neuron, the second neuron, and one or more other neurons between the first neuron and the second neuron. Each spiking neuron stores a forward depth value that indicates a distance from the first neuron.

In some embodiments, a path of the forward spike propagation comprises a first spiking neuron and a second spiking neuron that are between the first neuron and the second neuron. The first spiking neuron is closer to the first neuron than the second spiking neuron in the path of the forward spike propagation. The forward depth value of the second spiking neuron is determined based on a spike received from the first spiking neuron.

The graph search system 100 causes 730 a backward spike propagation comprising propagation of one or more spikes from the second neuron to the first neuron, wherein the backward spike propagation is after the forward spike propagation. In some embodiments, each spiking neuron stores a backward depth value that is determined based on a spike from the second neuron in the backward spike propagation.

The graph search system 100 identifies 740 a path in the graph based on the forward spike propagation and the backward spike propagation. The path is between a first node encoded by the first neuron and a second node encoded by the second neuron. In some embodiments, the graph comprises one or more other paths from the first node to the second node, and the identified path is shorter than the one or more other paths.

In some embodiments, the graph search system 100 identifies one or more neurons that spike in the forward spike propagation and in the backward spike propagation. The graph search system 100 identifies one or more nodes in the graph that are encoded by the one or more neurons. The path in the graph comprises connections among the first node, the one or more nodes, and the second node. In some embodiments, the graph search system 100 determines that a node in the graph is on the path based on a determination that a forward depth value of a spiking neuron encoding the node matches a backward depth value of the spiking neuron encoding the node.

### Example Computing Device

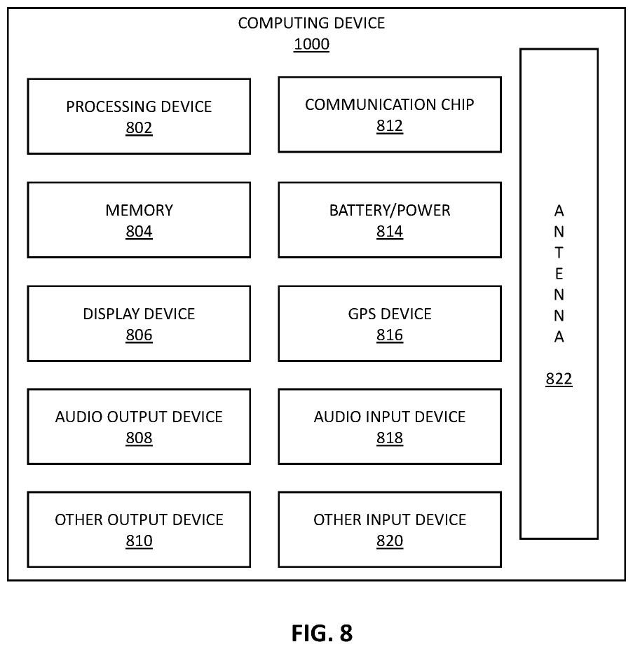

FIG. 8 is a block diagram of an example computing device 800, in accordance with various embodiments. In some embodiments, the computing device 800 may be used for at least part of the graph search system 100 in FIG. 1. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include an audio input device 818 or an audio output device 808, but may include audio input or output device interface circuitry (e.g., connectors and supporting circuitry) to which an audio input device 818 or audio output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 804 may include memory that shares a die with the processing device 802. In some embodiments, the memory 804 includes one or more non-transitory computer-readable media storing instructions executable for graph search, e.g., the method 700 described above in conjunction with FIG. 7 or some operations performed by the graph search system 100 in FIG. 1. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include an audio codec, a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### Selected Examples

The following paragraphs provide various examples of the embodiments disclosed herein.

Example 1 provides a computer-implemented method, including encoding a graph in a neural network, the graph including a plurality of nodes connected with one or more edges, the neural network including a plurality of neurons with one or more connections, each node encoded in a neuron in the neural network; causing a forward spike propagation comprising propagation of one or more spikes from a first neuron in the neural network to a second neuron in the neural network; causing a backward spike propagation comprising propagation of one or more spikes from the second neuron to the first neuron, where the backward spike propagation is after the forward spike propagation; and identifying a path in the graph based on the forward spike propagation and the backward spike propagation, where the path is between a first node encoded by the first neuron and a second node encoded by the second neuron.

Example 2 provides the computer-implemented method of example 1, where the graph includes one or more other paths from the first node to the second node, and the identified path is shorter than the one or more other paths.

Example 3 provides the computer-implemented method of example 1 or 2, where the forward spike propagation has a plurality of spiking neurons that includes the first neuron, the second neuron, and one or more other neurons between the first neuron and the second neuron, and each spiking neuron stores a forward depth value that indicates a distance from the first neuron.

Example 4 provides the computer-implemented method of example 3, where a path of the forward spike propagation includes a first spiking neuron and a second spiking neuron that are between the first neuron and the second neuron, the first spiking neuron is closer to the first neuron than the second spiking neuron in the path of the forward spike propagation, and a forward depth value of the second spiking neuron is determined based on a spike received from the first spiking neuron.

Example 5 provides the computer-implemented method of example 3 or 4, where each spiking neuron stores a backward depth value that is determined based on a spike from the second neuron in the backward spike propagation.

Example 6 provides the computer-implemented method of example 5, where identifying the path in the graph includes determining that a node in the graph is on the path based on a determination that a forward depth value of a spiking neuron encoding the node matches a backward depth value of the spiking neuron encoding the node.

Example 7 provides the computer-implemented method of any of the preceding examples, where identifying the path in the graph includes identifying one or more neurons that spike in the forward spike propagation and in the backward spike propagation; and identifying one or more nodes in the graph that are encoded by the one or more neurons, wherein the path comprises connections among the first node, the one or more nodes, and the second node.

Example 8. One or more non-transitory computer-readable media storing instructions executable to perform operations, the operations including encoding a graph in a neural network, the graph including a plurality of nodes connected with one or more edges, the neural network including a plurality of neurons with one or more connections, each node encoded in a neuron in the neural network; causing a forward spike propagation comprising propagation of one or more spikes from a first neuron in the neural network to a second neuron in the neural network; causing a backward spike propagation comprising propagation of one or more spikes from the second neuron to the first neuron, where the backward spike propagation is after the forward spike propagation; and identifying a path in the graph based on the forward spike propagation and the backward spike propagation, where the path is between a first node encoded by the first neuron and a second node encoded by the second neuron.

Example 9 provides the one or more non-transitory computer-readable media of example 8, where the graph includes one or more other paths from the first node to the second node, and the identified path is shorter than the one or more other paths.

Example 10 provides the one or more non-transitory computer-readable media of example 8 or 9, where the forward spike propagation has a plurality of spiking neurons that includes the first neuron, the second neuron, and one or more other neurons between the first neuron and the second neuron, and each spiking neuron stores a forward depth value that indicates a distance from the first neuron.

Example 11 provides the one or more non-transitory computer-readable media of example 10, where a path of the forward spike propagation includes a first spiking neuron and a second spiking neuron that are between the first neuron and the second neuron, the first spiking neuron is closer to the first neuron than the second spiking neuron in the path of the forward spike propagation, and a forward depth value of the second spiking neuron is determined based on a spike received from the first spiking neuron.

Example 12 provides the one or more non-transitory computer-readable media of example 10 or 11, where each spiking neuron stores a backward depth value that is determined based on a spike from the second neuron in the backward spike propagation.

Example 13 provides the one or more non-transitory computer-readable media of example 12, where identifying the path in the graph includes determining that a node in the graph is on the path based on a determination that a forward depth value of a spiking neuron encoding the node matches a backward depth value of the spiking neuron encoding the node.

Example 14 provides the one or more non-transitory computer-readable media of any one of examples 8-13, where identifying the path in the graph includes identifying one or more neurons that spike in the forward spike propagation and in the backward spike propagation; and identifying one or more nodes in the graph that are encoded by the one or more neurons, wherein the path comprises connections among the first node, the one or more nodes, and the second node.

Example 15 provides an apparatus, including a computer processor for executing computer program instructions; and a non-transitory computer-readable memory storing computer program instructions executable by the computer processor to perform operations including encoding a graph in a neural network, the graph including a plurality of nodes connected with one or more edges, the neural network including a plurality of neurons with one or more connections, each node encoded in a neuron in the neural network, causing a forward spike propagation comprising propagation of one or more spikes from a first neuron in the neural network to a second neuron in the neural network, causing a backward spike propagation comprising propagation of one or more spikes from the second neuron to the first neuron, where the backward spike propagation is after the forward spike propagation, and identifying a path in the graph based on the forward spike propagation and the backward spike propagation, where the path is between a first node encoded by the first neuron and a second node encoded by the second neuron.

Example 16 provides the apparatus of example 15, where the graph includes one or more other paths from the first node to the second node, and the identified path is shorter than the one or more other paths.

Example 17 provides the apparatus of example 15 or 16, where the forward spike propagation has a plurality of spiking neurons that includes the first neuron, the second neuron, and one or more other neurons between the first neuron and the second neuron, and each spiking neuron stores a forward depth value that indicates a distance from the first neuron.

Example 18 provides the apparatus of example 17, where a path of the forward spike propagation includes a first spiking neuron and a second spiking neuron that are between the first neuron and the second neuron, the first spiking neuron is closer to the first neuron than the second spiking neuron in the path of the forward spike propagation, and a forward depth value of the second spiking neuron is determined based on a spike received from the first spiking neuron.

Example 19 provides the apparatus of example 17 or 18, where each spiking neuron stores a backward depth value that is determined based on a spike from the second neuron in the backward spike propagation.

Example 20 provides the apparatus of example 19, where identifying the path in the graph includes determining that a node in the graph is on the path based on a determination that a forward depth value of a spiking neuron encoding the node matches a backward depth value of the spiking neuron encoding the node.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
encoding a graph in a neural network, the graph comprising a plurality of nodes connected with one or more edges, the neural network comprising a plurality of neurons with one or more connections, each node encoded in a neuron in the neural network;
causing a forward spike propagation comprising propagation of one or more spikes from a first neuron in the neural network to a second neuron in the neural network;
causing a backward spike propagation comprising propagation of one or more spikes from the second neuron to the first neuron, wherein the backward spike propagation is after the forward spike propagation; and
identifying a path in the graph based on the forward spike propagation and the backward spike propagation, wherein the path is between a first node encoded by the first neuron and a second node encoded by the second neuron.

2. The computer-implemented method of claim 1, wherein the graph comprises one or more other paths from the first node to the second node, and the identified path is shorter than the one or more other paths.

3. The computer-implemented method of claim 1, wherein:
the forward spike propagation has a plurality of spiking neurons that comprises the first neuron, the second neuron, and one or more other neurons between the first neuron and the second neuron, and
each spiking neuron stores a forward depth value that indicates a distance from the first neuron.

4. The computer-implemented method of claim 3, wherein:
a path of the forward spike propagation comprises a first spiking neuron and a second spiking neuron that are between the first neuron and the second neuron,
the first spiking neuron is closer to the first neuron than the second spiking neuron in the path of the forward spike propagation, and
a forward depth value of the second spiking neuron is determined based on a spike received from the first spiking neuron.

5. The computer-implemented method of claim 3, wherein each spiking neuron stores a backward depth value that is determined based on a spike from the second neuron in the backward spike propagation.

6. The computer-implemented method of claim 5, wherein identifying the path in the graph comprises:
determining that a node in the graph is on the path based on a determination that a forward depth value of a spiking neuron encoding the node matches a backward depth value of the spiking neuron encoding the node.

7. The computer-implemented method of claim 1, wherein identifying the path in the graph comprises:
identifying one or more neurons that spike in the forward spike propagation and in the backward spike propagation; and
identifying one or more nodes in the graph that are encoded by the one or more neurons,
wherein the path comprises connections among the first node, the one or more nodes, and the second node.

8. One or more non-transitory computer-readable media storing instructions executable to perform operations, the operations comprising:
encoding a graph in a neural network, the graph comprising a plurality of nodes connected with one or more edges, the neural network comprising a plurality of neurons with one or more connections, each node encoded in a neuron in the neural network;
causing a forward spike propagation comprising propagation of one or more spikes from a first neuron in the neural network to a second neuron in the neural network;
causing a backward spike propagation comprising propagation of one or more spikes from the second neuron to the first neuron, wherein the backward spike propagation is after the forward spike propagation; and
identifying a path in the graph based on the forward spike propagation and the backward spike propagation, wherein the path is between a first node encoded by the first neuron and a second node encoded by the second neuron.

9. The one or more non-transitory computer-readable media of claim 8, wherein the graph comprises one or more other paths from the first node to the second node, and the identified path is shorter than the one or more other paths.

10. The one or more non-transitory computer-readable media of claim 8, wherein:
the forward spike propagation has a plurality of spiking neurons that comprises the first neuron, the second neuron, and one or more other neurons between the first neuron and the second neuron, and
each spiking neuron stores a forward depth value that indicates a distance from the first neuron.

11. The one or more non-transitory computer-readable media of claim 10, wherein:
a path of the forward spike propagation comprises a first spiking neuron and a second spiking neuron that are between the first neuron and the second neuron,
the first spiking neuron is closer to the first neuron than the second spiking neuron in the path of the forward spike propagation, and
a forward depth value of the second spiking neuron is determined based on a spike received from the first spiking neuron.

12. The one or more non-transitory computer-readable media of claim 10, wherein each spiking neuron stores a backward depth value that is determined based on a spike from the second neuron in the backward spike propagation.

13. The one or more non-transitory computer-readable media of claim 12, wherein identifying the path in the graph comprises:
determining that a node in the graph is on the path based on a determination that a forward depth value of a spiking neuron encoding the node matches a backward depth value of the spiking neuron encoding the node.

14. The one or more non-transitory computer-readable media of claim 8, wherein identifying the path in the graph comprises:
identifying one or more neurons that spike in the forward spike propagation and in the backward spike propagation; and
identifying one or more nodes in the graph that are encoded by the one or more neurons,
wherein the path comprises connections among the first node, the one or more nodes, and the second node.

15. An apparatus, comprising:
a computer processor for executing computer program instructions; and
a non-transitory computer-readable memory storing computer program instructions executable by the computer processor to perform operations comprising:
encoding a graph in a neural network, the graph comprising a plurality of nodes connected with one or more edges, the neural network comprising a plurality of neurons with one or more connections, each node encoded in a neuron in the neural network,
causing a forward spike propagation comprising propagation of one or more spikes from a first neuron in the neural network to a second neuron in the neural network,
causing a backward spike propagation comprising propagation of one or more spikes from the second neuron to the first neuron, wherein the backward spike propagation is after the forward spike propagation, and
identifying a path in the graph based on the forward spike propagation and the backward spike propagation, wherein the path is between a first node encoded by the first neuron and a second node encoded by the second neuron.

16. The apparatus of claim 15, wherein the graph comprises one or more other paths from the first node to the second node, and the identified path is shorter than the one or more other paths.

17. The apparatus of claim 15, wherein:
the forward spike propagation has a plurality of spiking neurons that comprises the first neuron, the second neuron, and one or more other neurons between the first neuron and the second neuron, and
each spiking neuron stores a forward depth value that indicates a distance from the first neuron.

18. The apparatus of claim 17, wherein:
a path of the forward spike propagation comprises a first spiking neuron and a second spiking neuron that are between the first neuron and the second neuron,
the first spiking neuron is closer to the first neuron than the second spiking neuron in the path of the forward spike propagation, and
a forward depth value of the second spiking neuron is determined based on a spike received from the first spiking neuron.

19. The apparatus of claim 17, wherein each spiking neuron stores a backward depth value that is determined based on a spike from the second neuron in the backward spike propagation.

20. The apparatus of claim 19, wherein identifying the path in the graph comprises:
determining that a node in the graph is on the path based on a determination that a forward depth value of a spiking neuron encoding the node matches a backward depth value of the spiking neuron encoding the node.
